(19) United States
(12) Patent Application Publication
(10) Pub. No.: US 2016/0126809 A1
(43) Pub. Date: May 5, 2016

(54) Electric-Electronic Actuator

(71) Applicant: INTERNATIONAL ENGINE INTELLECTUAL PROPERTY COMPANY, LLC, Lisle, IL (US)

(72) Inventor: Oswald Baasch, Bowling Green, KY (US)

(73) Assignee: International Engine Intellectual Property Company, LLC, Lisle, IL (US)

(21) Appl. No.: 14/893,336

(22) PCT Filed: May 24, 2013
(86) PCT No.: PCT/US13/42742

§ 371 Date: Nov. 23, 2015

(51) Int. Cl. H02K 9/20; H02K 5/20

(52) U.S. Cl. CPC H02K 9/20; H02K 5/20

(57) ABSTRACT

An actuator housing assembly that includes an actuator housing that has a cavity that contains a phase-change material that is configured to continue to absorb heat as the phase-change material changes phases. The actuator housing assembly also includes an electronic actuator that is secured to the actuator housing. At least a portion of the cavity may be positioned to surround at least a portion of the electronic actuator. The phase-change material is configured to prevent the transfer of heat in the actuator housing to the electronic actuator. The actuator housing may also include an electronic control board that is used in controlling the operation of the electronic actuator.

### BACKGROUND

Illustrated embodiments relate to the protection of electronic/electrical components from high temperature related damage. For example, certain embodiments relate to the use of phase changing materials to protect electronic/electrical engine management components used in the operation of a vehicle during high temperature excursions and/or due to hot soak conditions that may occur when a hot engine is shut down.

Engine management components are often used to control various aspects of the operation of an internal combustion engine and/or vehicle. During engine operation, the controller may provide instructions or data that is used to actuate actuators that are operably attached or coupled to one or more valves. The adjustment of a valve's position may be used to control a variety of different engine operations, including, for example, the rate or amount of fuel that is supplied through a fuel injector to a combustion chamber, the air-to-fuel ratio, ignition timing, the amount of exhaust gas that is re-circulated to the intake manifold, and idle speed, among other operations.

Engine management components, such as, for example, actuators, have traditionally been mechanically, pneumatically, and/or hydraulically activated. However, mechanical, pneumatic, and/or hydraulic actuators may suffer from low positional accuracy and response rate. For example, pneumatic/electro-pneumatic valve actuation may suffer from low positional accuracy due to the compressible nature of the fluids being used, such as air, and the moisture generated in an associated air compression system.

Additionally, engine management components may also be designed to be electric/electronically activated. Yet, electric/electronically activated engine management components, such as actuators, may be more sensitive to higher temperature operating environments than their mechanical, pneumatic, and/or hydraulic counterparts. Moreover, the reliability and/or life span of electric valve actuation components may be hindered by the harsh operating environments that may be present in the engine compartment or other areas of the vehicle, including exposure to surrounding elevated temperatures and relatively large temperature fluctuations.

### BRIEF SUMMARY

According to an illustrated embodiment, an actuator assembly is provided. The actuator assembly includes an actuator housing that houses an electronic actuator. Further, the actuator housing has a cavity that contains a phase-change material (PCM). The PCM is formulated or otherwise compounded to absorb heat and change phase at the phase change temperature of the PCM. Additionally, the PCM is also formulated to continue absorbing heat as the PCM changes phases at the prescribed, phase change temperature threshold.

According to another illustrated embodiment, an actuator assembly is provided that includes an actuator housing that has a cavity that contains a PCM. The PCM is formulated or otherwise compounded to absorb heat and change phase when the PCM reaches its phase change temperature. Additionally, the PCM is also formulated to continue absorbing heat as the PCM changes phases at the phase change temperature of the PCM. The actuator assembly also includes an electronic actuator that is secured to the actuator housing. Additionally, at least a portion of the cavity is configured to surround at least a portion of the electronic actuator. Further, the PCM is configured to prevent the transfer of heat in the actuator housing to the electronic actuator.

According to another embodiment, an exhaust gas recirculation valve is provided that includes an actuator assembly having an actuator housing, an electronic actuator, and an electronic control board. The actuator housing includes a cavity that has a ring portion that generally surrounds at least a portion of the electronic actuator. At least a portion of the cavity contains a PCM that is formulated to absorb heat and change phase at the phase change temperature of the PCM. Additionally, the PCM is also formulated to continue absorbing heat as the PCM changes phases at the phase change temperature. The exhaust gas recirculation valve also includes a valve housing that is operably secured to the actuator housing. The valve housing has a coolant inlet, a coolant passageway, and a coolant outlet. The coolant passageway is configured to prevent, when the coolant passageway contains coolant, heat from the valve housing from transferring to the actuator housing.

### BRIEF DESCRIPTION OF SEVERAL VIEWS OF THE DRAWINGS

FIG. 1 illustrates a top partial cross sectional view of an exhaust gas recirculation (EGR) valve.

FIG. 2 illustrates a front side perspective partial cross sectional view of the EGR valve shown in FIG. 1.

FIG. 3 illustrates an exploded view of both a heat insulator and an actuator housing assembly that is operably connected to an electronic actuator and an electronic control board.

FIG. 4 illustrates a side perspective partial cross sectional view of an assembled actuator housing assembly and heat insulator.

FIG. 5 illustrates a rear side partial cross sectional view of the housing of FIG. 1.

FIG. 6 illustrates a side perspective partial side cross sectional view of the assembled actuator housing assembly.

FIG. 7 illustrates a side perspective partial side cross sectional view of the assembled actuator housing assembly.

### DETAILED DESCRIPTION

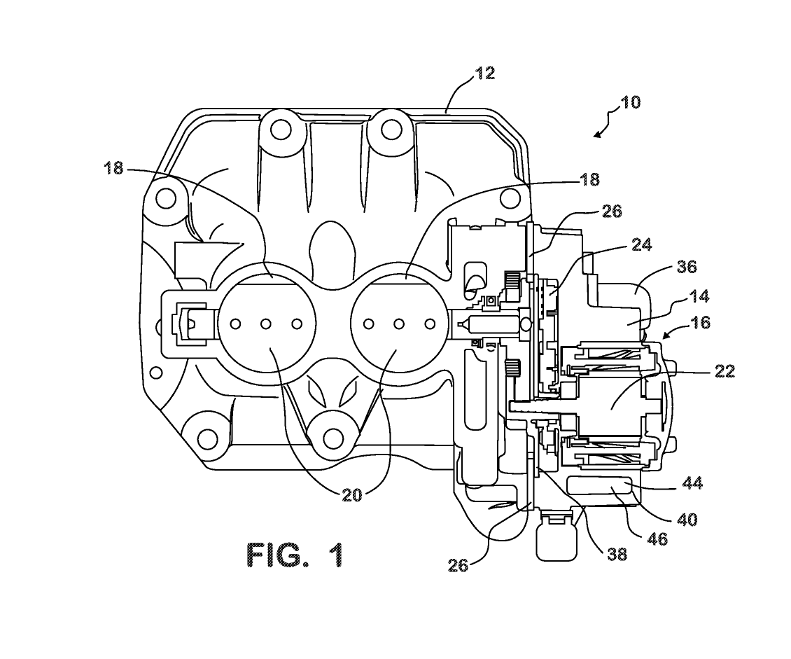

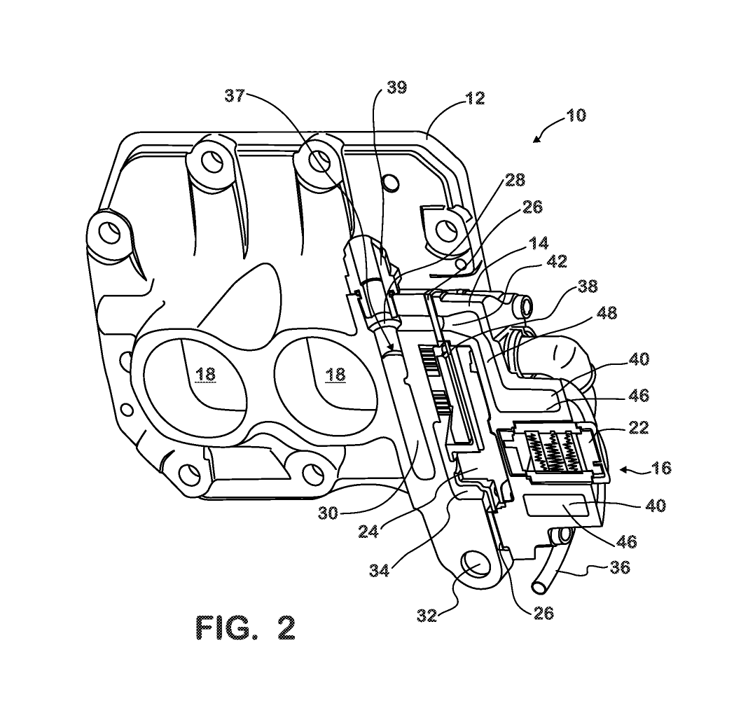

Referencing FIGS. 1-2, embodiments are discussed herein with respect to an exhaust gas recirculation (EGR) valve 10. The EGR valve 10 may be used to at least assist in controlling the flow of exhaust gas exiting the engine through the exhaust manifold back to the intake manifold of the engine. Moreover, the EGR valve 10 may assist in controlling the recirculation of exhaust gas back to the combustion chamber of an internal combustion engine, where the inclusion of the exhaust gas in the combustion chamber may lower the temperatures generated during combustion events that are used to displace the piston(s) of an internal combustion engine.

The EGR valve 10 may include a valve housing 12 and an actuator housing 14. The valve housing 12 includes openings 18 that are configured to receive the placement of valve plates 20. Moreover, the valve plates 20 may be rotated between open and closed positions, as well as positions there-between, by an electronically controlled electronic actuator 22 that is housed in the actuator housing 14. Moreover, when the valve plates 20 are fully in an open position, the valve plates 20 may not generally impede the flow of exhaust gas through the openings 18. Conversely, when fully in the closed position, the valve plates 20 may be positioned to generally prevent the flow the exhaust gases through the openings 18.

The temperature of the exhaust gas flowing through the openings 18 may depend on a number of factors, including, for example, the length of time the engine has been operating, the temperature of the surrounding environment, and the power being provided by and/or load on the engine, among other factors. For example, during certain periods of operation, the exhaust gases flowing through the openings 18 may attain temperatures in excess of 700° Celsius. Such elevated temperatures of the exhaust gas may have a tendency to increase the temperature of the valve housing 12 through which the exhaust gas passes through. Further, heat paths may develop across the valve housing 12 as well as to other components that are connected and/or in proximity to which the valve housing 12, thereby elevating the temperatures of those other components. Additionally, the temperature of the valve housing 12 may also increase due to the surrounding hot operating environment or due to other hot components in the engine compartment, such as, for example, through convection and/or radiation.

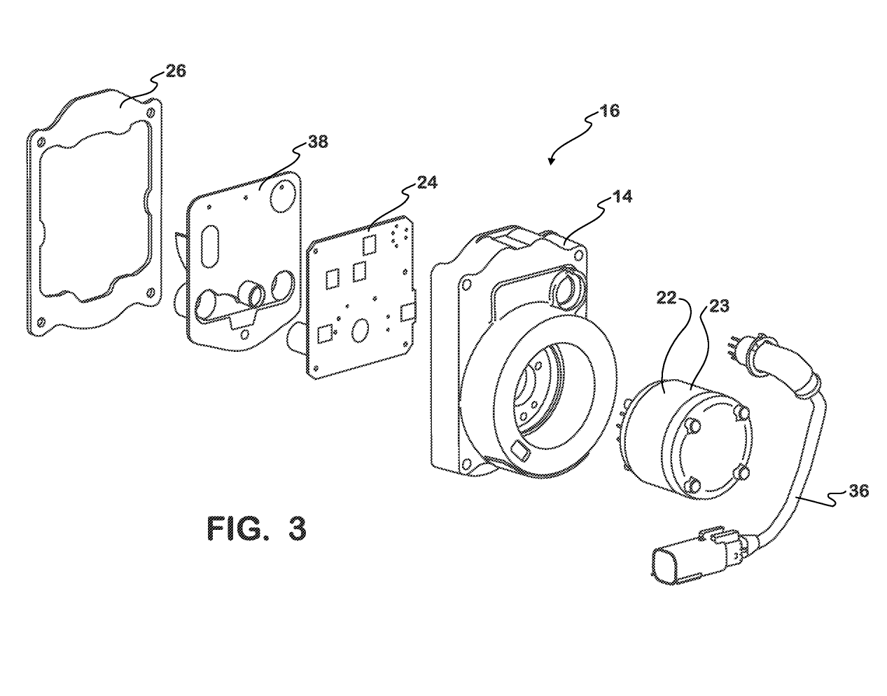

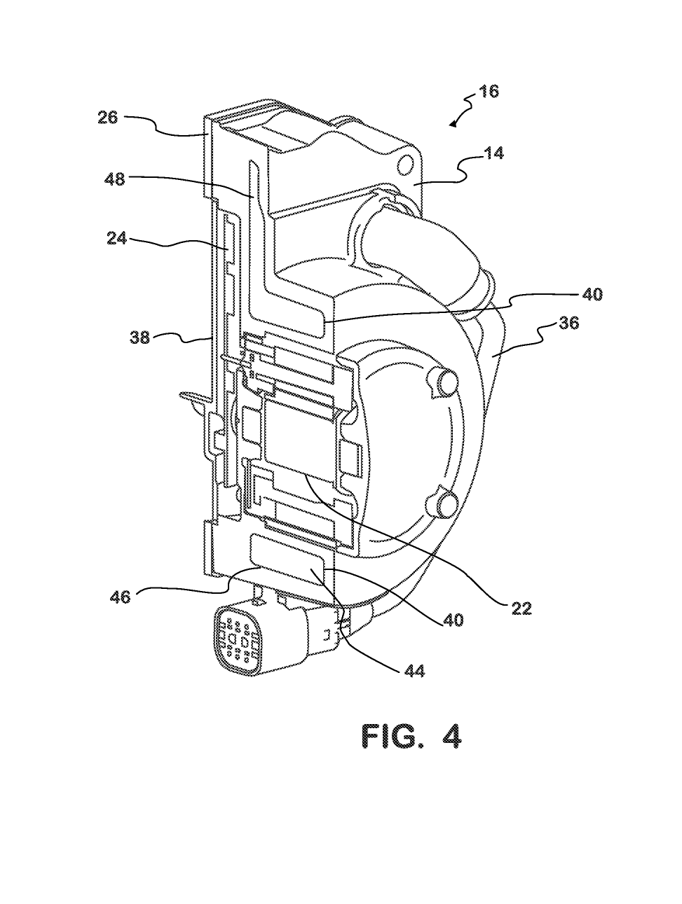

FIGS. 3 and 4 illustrated an exploded and partial cross sectional views, respectively, of an actuator housing assembly 16. The actuator housing assembly 16 may be operably secured to the valve housing 12, such as, for example, by one or more bolts. Additionally, the actuator housing assembly 16 may include an electronic control board 24 and an electronic actuator 22 that are operably secured to, or otherwise housed by, the actuator housing 14. Various types of electronic actuators 22 may be housed by actuator housing 14, including, for example, a stepper motor, permanent magnet direct current (PMDC) motor, or brushless direct current (BLDC) motor, among others.

The electronic control board 24 is configured to deliver electrical current or signals used to operate the actuator 22, and thereby control the position of the valve plates 20 in the openings 18. According to certain embodiments, the electronic control board 24 includes a processor that is used in determining when and/or how much to activate the actuator 22 so as to change or adjust the position of the valve plates 20. Further, according to certain embodiments, the electronic control board 24 may receive instructions from a control unit or module, such as, for example, an engine control unit (ECU). Alternatively, the electronic control board 24 may receive signals indicating sensed operating conditions, such as, for example, signals from a temperature sensor, that provides information that the electronic control board 24 may utilize in determining whether to activate the actuator 22 to adjust the position of the associated valve. Accordingly, the electronic control board 24 may be operably connected to a cable 36, such as, for example, via cable pin-outs, which may deliver electronic signals and/or power from the ECU and/or sensors to the electronic control board 24. The backside of the electronic control board 24 may be covered by a backing plate 38. The backing plate 38 may be insulated from the valve housing 12, such as by a heat insulator 26, discussed below, or by other ceramic standoffs, heat insulator plates, and/or air gaps.

As previously discussed, the harsh operating conditions surrounding the actuator housing 14, such as the elevated temperatures of the exhaust gas flowing through the valve housing 12, may be detrimental to the reliability and/or durability of the electronic control board 24 and the electronic actuation of the actuator 22. Accordingly, the valve housing 12 and actuator housing 14 may be configured to minimize the number of heat paths between each other. One way to minimize such heat paths is to minimize the physical contact between the valve and actuator housings 12, 14. Such minimal contact may be established at least in part, through the placement of a heat insulator 26 between the valve housing 12 and actuator housing 14. According to certain embodiments, the heat insulator 26 may be a gasket, as illustrated in FIGS. 1-4, that separates at least a portion of the valve and actuator housings 12, 14 so that the valve housing 12 is not in physical contact with the actuator housing 14. The heat insulator 26 may be made from a variety of different materials that have low heat transfer properties, including, for example, fiberglass, silica, and ceramic fiber, among others.

Further, in addition to, or in lieu of the heat insulator, the valve housing 12 and/or the actuator housing 14 may be configured such that, when secured to each other, an air gap is present between at least a portion of the valve housing 12 and the actuator housing 14. The air gap may provide additional thermal insulation that prevents or minimizes the transfer of heat from the valve housing 12 to the actuator housing 14. For example, according to certain embodiments, the backing plate 38 of the actuator housing assembly 16 may be offset from an adjacent surface of the valve housing 12 such that an air gap is between the backing plate 38 and the valve housing 12.

In addition to minimizing heat paths between the valve housing 12 and the actuator housing 14, a coolant, such as air, water, or other liquid coolant, may be circulated between the valve housing 12 and the actuator housing 14. The coolant may further shield and/or reduce heat transfer from the valve housing 12 to the actuator housing 14. For example, referencing FIGS. 2 and 3, the valve housing 12 may include a coolant system 37 that includes a coolant inlet 28, a coolant passageway 30, and a coolant outlet 32. The coolant passageway 30 may be generated or formed in the valve housing 12 by casting processes such as lost foam, investment casting, or sand casting that utilizes specialized cores. The coolant inlet and outlet 28, 32 may be adapted to engage conventional steel fittings or connectors 39 that are used for connection to coolant lines or tubes.

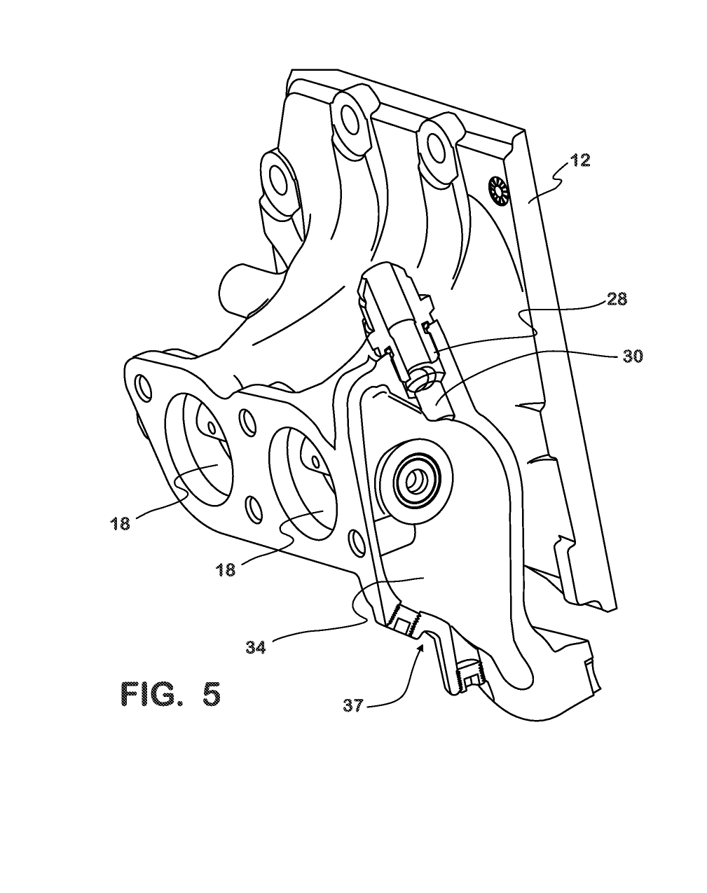

The coolant passing through the coolant passageway 30 may absorb heat from the valve housing 12 and/or actuator housing 14 so as to at least attempt to reduce the temperature of the actuator housing 14, and more specifically, to reduce the temperature about the electronic actuator 22 and/or electronic control board 24. For example, according to the embodiment illustrated in FIG. 5, at least a portion of the coolant passageway 30 may have a tear drop shaped coolant reservoir 34 that is larger than other portions of the coolant passageway 30. Such a configuration may allow a relatively large quantity to coolant to accumulate at or near where the actuator housing 14 is adjacent to the valve housing 12 so that the accumulate coolant may provide a curtain or wall of coolant that further prevents or minimizes the transfer of heat from the valve housing 12 to the actuator housing 14. Additionally, according to certain embodiments, the coolant reservoir 34 may also assist in absorbing heating from the actuator housing 14.

However, in many vehicles, the flow of coolant may cease when the engine is turned off. Under certain conditions, when coolant flow has stopped, the elevated temperature of the exhaust gas, valve housing 12, actuator housing 14, and/or engine compartment, among others, may cause coolant remaining in the coolant passageway 30 to boil and turn to a gas, thus rendering the coolant generally ineffective in continuing to reduce the temperature of the actuator housing 14. Moreover, heat transfer via conduction, convection, and/or radiation may elevate the temperature of the electronic control board 24 and/or actuator 22 to undesirably high levels that may damage or otherwise short the life span of those components.

Accordingly, the actuator housing 14 may include cavities that contain a phase-change material (PCM) that may also absorb heat so as to protect the electronic control board 24 and/or actuator 22 from potentially damaging elevated temperatures. The PCM(s) may, for example, be a substance that undergoes changes phases, such as, between solid to solid, solid to liquid, or liquid to gas phases when the PCM has absorbed sufficient heat to be elevated to a phase change temperature. Additionally, PCMs not only absorb heat when reaching its phase change temperature, but also continue to absorb after reaching its phase change temperature without a significant rise in temperature until all the material of the PCM changes its phase. Thus, PCMs changing from a solid to a liquid or from a liquid to a gas continue to absorb heat from its surroundings. Accordingly, PCMs are capable of storing and releasing relatively large amounts of energy. When surrounding temperatures are reduced, such as during a cool down, the PCM will revert back to its original phase, such as, for example going for a liquid phase back to a solid phase.

The phase change temperature of the PCM(s) housed within the cavities of the actuator housing 14 may be the specific temperature threshold(s) at which the PCM(s) is/are formulated to change its/their phase. For example, during shut down of a hot engine, the temperature of the actuator housing 14 may exceed the maximum operating temperature of the electronic control board 24 and/or the actuator 22. Accordingly, in an effort to protect the electronic control board 24 and/or the actuator 22 from heat related damage, the PCM(s) may be formulated such that the PCM's phase change temperature is generally at or below the maximum operating temperature of the electronic control board 24 and/or the actuator 22.

FIG. 2 illustrates a cavity 40 in the actuator housing 14 that is configured to receive the insertion of a PCM. The cavity 40 may be configured to have sufficient volume to not only contain the PCM but to also accommodate expansion of the PCM related to the PCM changing its phase. According to certain embodiments, the PCM may at least initially be injected into the cavity 40 in a granular or melted, liquid form. In instances in which the PCM is injected into the cavity in granular form, the PCM may subsequently be dispersed throughout the cavity through the use of a vibratory process. After PCM has been placed in a cavity 40, the cavity 40 may be sealed or otherwise closed so as to prevent the loss of PCM. For example, referencing FIG. 2, the cavity 40 may have an opening 42 through which PCM material may be inserted, and which is sealed closed by the heat insulator 40 when the actuator housing 14 is assembled to the valve housing 12.

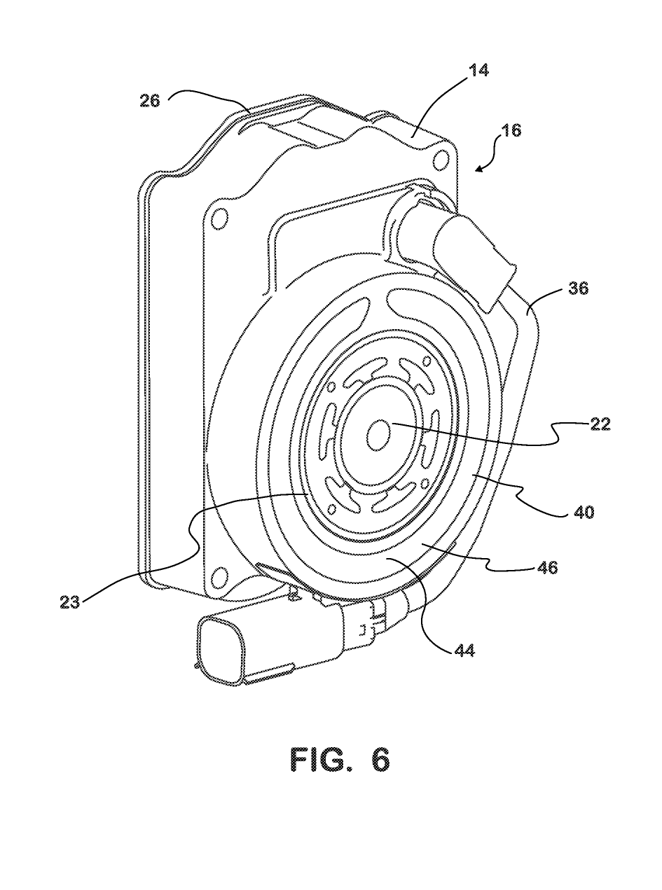

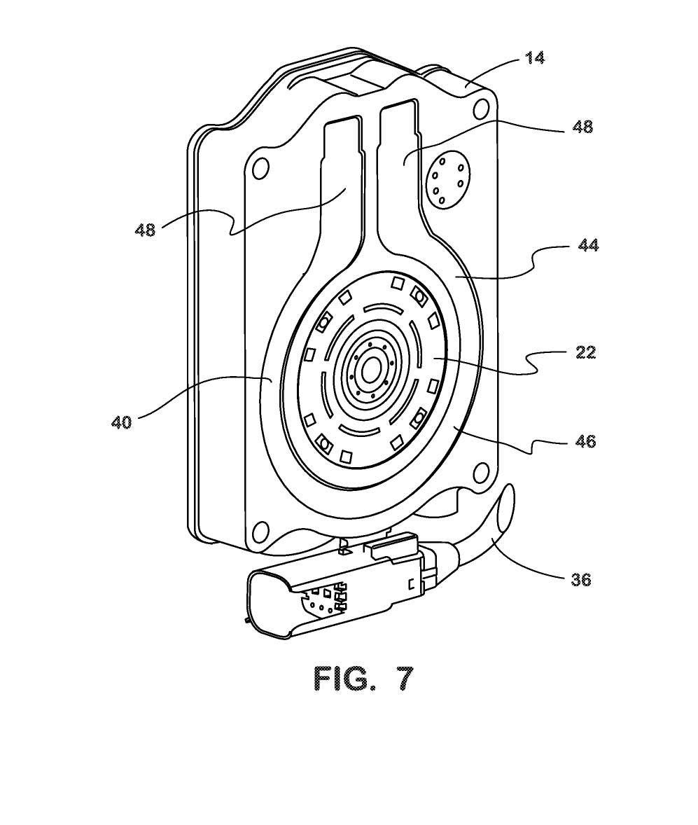

FIGS. 1, 6, and 7 illustrate PCM 44 in the cavity 40 of the actuator housing 14. A variety of different PCMs 44 may be employed, including, without limitation, categories of PCMs that include eutectics, salt hydrates, organic materials, and high temperature salts. As shown, the cavity 40 may include a ring portion 46 that is in fluid communication with at least one extension 48. The shape and configuration of the cavity 40 may further minimize or reduce heats path from the actuator housing 14 to the actuator 22. At least one of the at least one extensions 48 may be in fluid communication with the opening 42. The extension 48 may provide additional volume to accommodate expansion of the PCM 44 during phase change. According to the illustrated embodiment, the ring portion 46 may be configured to generally follow at least a portion of the outer surfaces 23 of the actuator 22 so that the ring portion 46 at least generally surrounds at least a portion of the actuator 22.

While the above illustrated embodiments are discussed with respect to an EGR valve 10, other embodiments may be directed to other engine components that house or include an electronic actuator and/or electronic control board, such as, for example engine control modules, transmission control modules, chassis control modules, engine component control modules, engine brushless direct current cooling fans, engine brushless direct current oil pumps, and valve lift and phase camshaft controls, among others. Additionally, embodiments may also be applied to non-automotive applications, including, industrial or domestic applications that involve electric control or energy storage systems that are exposed to high temperature conditions and/or generate heat through operation.

1. An actuator housing assembly comprising:
an actuator housing;
an electronic actuator housed by the actuator housing; and
a cavity in the actuator housing, the cavity containing a phase-change material, the phase-change material formulated to absorb heat and change phase when the phase-change material obtains a phase change temperature, the phase-change material also formulated to continue absorbing heat as the phase-change material changes phases.

2. The actuator housing assembly of claim 1, wherein the phase-change material is formulated such that the phase change temperature is generally around the maximum operating temperature of the electronic actuator.

3. The actuator housing assembly of claim 1, wherein at least a portion of the cavity is configured to surround at least a portion of the electronic actuator.

4. The actuator housing assembly of claim 1, wherein the phase-change material is selected from at least one of the following categories of phase change materials: (a) eutectics, (b) salt hydrates, (c) organic materials, or (d) high temperature salts.

5. The actuator housing assembly of claim 1, wherein the actuator housing is secured to a valve housing, the valve housing having a coolant inlet that is in fluid communication with a coolant reservoir, the coolant reservoir configured to accumulate coolant to provide a wall of coolant that shields at least a portion of the actuator housing from the transfer of heat from the valve housing.

6. An actuator housing assembly comprising:
an actuator housing, the actuator housing having a cavity that contains a phase-change material, the phase-change material formulated to absorb heat and change phase when the phase-change material obtains a phase change temperature, the phase-change material also formulated continue absorbing heat as the phase-change material changes phases; and
an electronic actuator secured to the actuator housing, at least a portion of the cavity configured to surround at least a portion of the electronic actuator, the phase-change material configured to prevent the transfer of heat in the actuator housing to the electronic actuator.

7. The actuator housing of claim 6 wherein the actuator housing also houses an electronic control board, the electronic control board configured to at least assist in controlling the operation of the electronic actuator.

8. The actuator housing of claim 7, wherein the phase-change material is selected from at least one of the following categories of phase change materials: (a) eutectics, (b) salt hydrates, (c) organic materials, or (d) high temperature salts.

9. The actuator housing of claim 8, wherein the actuator housing is secured to a valve housing, and further including a heat insulator positioned between at least a portion of the actuator housing and the valve housing when the actuator housing is secured to the valve housing to prevent the actuator housing from being in physical contact with the valve housing, the heat insulator having low heat transfer properties.

10. The actuator housing assembly of claim 9, wherein the valve housing includes a coolant inlet that is in fluid communication with a coolant reservoir, the coolant reservoir configured to accumulate a coolant to provide a wall of coolant that shields at least a portion of the actuator housing from the transfer of heat from the valve housing.

11. An exhaust gas recirculation valve comprising:
an actuator assembly having an actuator housing, an electronic actuator, and an electronic control board, the actuator housing having a cavity, the cavity including a ring portion that generally surrounds at least a portion of the electronic actuator, at least a portion of the cavity containing a phase-change material, the phase-change material formulated to absorb heat and change phase when the phase-change material obtains a phase change temperature, the phase-change material also formulated continue absorbing heat as the phase-change material changes phases;
a valve housing operably secured to the actuator housing, the valve housing having a coolant inlet, a coolant passageway, and a coolant outlet, the coolant passageway configured to prevent, when the coolant passageway contains coolant, heat from the valve housing from transferring to the actuator housing.

12. The exhaust gas recirculation valve of claim 11, further including a heat insulator positioned between at least a portion of the valve housing and the actuator housing, the heat insulator configured to prevent the actuator housing from physically contacting the valve housing, the heat insulator having low heat transfer properties.

13. The exhaust gas recirculation valve of claim 12, wherein the cavity further includes at least one extension in fluid communication with the ring portion, the at least one extension also being in fluid communication with an opening, the opening being closed by the heat insulator when the actuator housing is secured to the valve housing.

14. The exhaust gas recirculation valve of claim 13, wherein the phase-change material is formulated such that the phase change temperature is generally around the maximum operating temperature of the electronic actuator.

15. The exhaust gas recirculation valve of claim 11 further including an air gap between the valve housing and the actuator housing, the air gap configured to minimize the transfer of heat from the valve housing to the actuator housing.
